(19) United States
(12) Patent Application Publication
(10) Pub. No.: US 2013/0208964 A1
(43) Pub. Date: Aug. 15, 2013

(54) SYSTEM FOR THE SEGMENTATION OF A MEDICAL IMAGE

(71) Applicant: Shekhar Dwivedi, Lucknow (IN)

(72) Inventor: Shekhar Dwivedi, Lucknow (IN)

(73) Assignee: KONINKLIJKE PHILIPS ELECTRONICS N.V., EINDHOVEN (NL)

(21) Appl. No.: 13/880,991

(22) PCT Filed: Oct. 17, 2011
(86) PCT No.: PCT/IB11/54584

§ 371 Date: Apr. 23, 2013

(30) Foreign Application Priority Data
Oct. 25, 2010 (EP) 10188714.9

(51) Int. Cl. G06K 9/34

(52) U.S. Cl. CPC G06K 9/34
USPC 382/128

(57) ABSTRACT

A system (100) for processing a medical image, the system comprising an input (110) for receiving the medical image; a processor (120) for obtaining an image characteristic of the medical image; a categorizer (130) for obtaining a category of the medical image in dependence on the image characteristic; and an algorithm selector (140) for configuring a segmentation means (150) by selecting a segmentation algorithm amongst a plurality of segmentation algorithms in dependence on the category, for enabling the segmentation (150) means to segment the medical image with the segmentation algorithm for obtaining a region of interest.

### FIELD OF THE INVENTION

The invention relates to a system for, and a method of, enabling segmentation of a medical image for obtaining a region of interest within the medical image.

### BACKGROUND OF THE INVENTION

In the field of medical imaging, a medical image may comprise a region that is of particular interest to a health care professional. For example, in a cardiac image acquired by Single Photon Emission Computed Tomography (SPECT), a region comprising the heart's left ventricle may allow assessment of how well the heart pumps blood to the body.

It may be desirable to automatically segment a region of interest in a medical image, for example for enabling Computer-Aided Detection (CAD) of a medical condition or for alerting the health care professional to the presence of the region of interest.

US 2006/0270912 describes a medical imaging system comprising means for segmenting a region around a region of interest within a volume of 3D data. The means for segmenting the region uses a sensitivity of the segmentation technique that is chosen so that the segmented region entirely contains the region of interest. The system further comprises a correction means for correcting the segmented region by excluding sub-regions from the segmented region so that it corresponds as precisely as possible to the boundaries of the region of interest. The correction means may be automatic, semi-automatic, or manual. Thus, the correction means enables a more precise segmentation of the region of interest.

A problem of the above system is that the system may obtain an insufficiently precise segmentation of the region of interest.

### SUMMARY OF THE INVENTION

It would be advantageous to have a system or a method for obtaining a more precise segmentation of the region of interest.

To better address this concern, a first aspect of the invention provides a system for processing a medical image, the system comprising an input for receiving the medical image, a processor for obtaining an image characteristic of the medical image, a categorizer for obtaining a category of the medical image in dependence on the image characteristic, and an algorithm selector for configuring a segmentation means by selecting a segmentation algorithm amongst a plurality of segmentation algorithms in dependence on the category, for enabling the segmentation means to segment the medical image with the segmentation algorithm for obtaining a region of interest.

The system receives a medical image, using a receiving means in the form of an input. A processor provides an image characteristic of the received medical image. The image characteristic is a measurable and visual aspect of the medical image. A categorizer uses the image characteristic to determine to what kind of category the received medical image belongs. Furthermore, the system is used together with a segmentation means. The segmentation means comprises a number of different segmentation algorithms for segmenting the medical image to obtain a segmented region of interest. The system is able to instruct the segmentation means to use a specific one of the segmentation algorithms by using the algorithm selector. For determining which is the specific one of the segmentation algorithms, the system makes use of the earlier determined category of the medical image.

The invention is partially based on the recognition that the image characteristics of medical images may be so different that a single segmentation algorithm may not be sufficiently adaptable to always obtain a precisely segmented region of interest.

The above measures have the effect that the segmentation means is instructed to segment the region of interest within the medical image, using a specific one of the segmentation algorithms that is associated with the particular category of the medical image. Thus, a specifically chosen segmentation algorithm is used for segmenting the medical image when the medical image has a certain image characteristic. Each different segmentation algorithm performs well for a specific category of medical images. By selecting the most suitable of the segmentation algorithms for each specific category of medical images, a more precise segmentation is obtained. Advantageously, each of the segmentation algorithms may have been specifically optimized for a different category of medical image, and the system enables precise segmentation of each category of medical images by selecting the specifically optimized segmentation algorithm. Advantageously, segmentation algorithms that are suitable for one category, yet unsuitable for another category, can nevertheless be used, as said algorithms are only selected if the medical image belongs to said one category.

Optionally, the processor is configured for obtaining the image characteristic by determining an intensity distribution of at least a first portion of the medical image.

The image characteristic is therefore indicative of how intensity values from at least the first portion of the medical image are distributed. The intensity distribution may relate to a spatial distribution of intensities within the first portion, and thus relate to how intensity values are spatially positioned within the first portion of the medical image. The spatial positioning may be indicative of a shape formed by intensity values falling within a certain range. Advantageously, the categorizer may use the shape of relatively high intensity values to categorize the medical image.

Optionally, the intensity distribution is an intensity frequency distribution. The image characteristic is now indicative of a statistical frequency distribution of intensity values from at least the first portion of the medical image. A statistical frequency distribution corresponds to an occurrence frequency of the intensity values. Thus, the categorizer uses the occurrence frequency of intensity values to categorize the medical image. The categorizer may therefore categorize the medical image, based on a property of the intensity frequency distribution, such as its shape or form.

Optionally, the categorizer is configured for categorizing the medical image by determining a slope or a peak of the intensity frequency distribution, and for categorizing the medical image in dependence on the slope or the peak.

A slope or a peak is an aspect of the intensity frequency distribution that is indicative of its shape or form. The slope or the peak may be determined in a relatively efficient manner. Hence, by determining the slope or the peak, the categorizer may categorize the medical image in dependence on the shape or form in a relatively efficient manner. This aspect of the invention is partially based on the recognition that a slope or a peak of the intensity frequency distribution allows the categorizer to distinguish between medical images comprising either substantially a single organ or multiple organs and/or non-organ structures. Advantageously, the categorizer may categorize medical images comprising a single organ differently from medical images comprising multiple organs and/or non-organ structures by determining whether an overall slope of the intensity frequency distribution is substantially monotonically declining. The system can therefore select different segmentation algorithms for each medical image.

Optionally, the processor comprises a pre-segmentation means for pre-segmenting the medical image for obtaining a first portion of the medical image, and the processor is configured for obtaining the image characteristic from the first portion.

The categorization of the medical image is thus based on the image characteristics of a certain portion of the medical image. By using a pre-segmentation of the medical image, it is possible to choose where the image characteristic originates from. For example, not all portions of the medical image may be equally relevant for determining the category of the medical image. Advantageously, if characteristics of the relevant portion are known, the pre-segmentation means may be arranged for pre-segmenting the relevant portion, and thus the categorizer can categorize the medical image based on the image characteristics of the relevant portion of the medical image.

Optionally, the pre-segmentation means is configured for pre-segmenting the medical image with a pre-segmentation algorithm associated with an organ, for obtaining as the first portion a portion of the medical image comprising the organ.

The categorization of the medical image is thus based on the image characteristics of a portion of the medical image comprising the organ. The image characteristics of the organ may be of particular relevance for determining the category of the medical image. Advantageously, the categorizer may categorize the medical image based on a type of the organ, or on specific characteristics of a specific type of organ.

Optionally, the processor is configured for obtaining the image characteristic by determining at least one of the group of: location, size, shape, average intensity or intensity distribution, of the first portion. Said image characteristics are relatively well suitable for categorizing the medical image.

Optionally, the pre-segmentation means is further configured for pre-segmenting the medical image for obtaining a second portion of the medical image, the processor is configured for obtaining a further image characteristic from the second portion, and the categorizer is configured for categorizing the medical image by comparing the image characteristic with the further image characteristic, and categorizing the medical image in dependence on the result of the comparing action.

The categorization of the medical image is thus based on a difference between the image characteristics of the first portion of the medical image and the image characteristics of the second portion of the medical image.

Optionally, the result of the comparing action is indicative of an overlap between the first portion and the second portion within the medical image. The categorizer thus uses an overlap between the first portion and the second portion to categorize the medical image. The overlap may be determined by, e.g., comparing a location or size of the first portion and the second portion. Advantageously, the categorizer may categorize medical images comprising at least partially overlapping organs differently from medical images not comprising at least partially overlapping organs. The system can therefore select different segmentation algorithms in dependence on an overlap of organs in the medical image.

Optionally, the processor is configured for obtaining the image characteristic by determining at least one of the group of: contrast, noise-level or sharpness, of at least a first portion of the medical image. The contrast, noise-level or sharpness are relatively well suitable for categorizing the medical image. Advantageously, the system may select, for low-contrast medical images, a specific segmentation algorithm that has segmentation thresholds that are adapted to low-contrast medical images. Advantageously, the system may select a specific segmentation algorithm for noisy medical images that performs a noise reduction before segmentation.

Optionally, the input is further configured for receiving metadata associated with the medical image, and the processor is configured for obtaining the image characteristic of the medical image from the metadata. The processor therefore obtains the image characteristic from the metadata instead of, or in addition to, obtaining the image characteristic from the medical image. Metadata may be available for a medical image from, e.g., the acquisition or generation of the medical image. The system is therefore able to use such metadata to obtain the image characteristic. Advantageously, the categorizer provides improved categorization of the medical image.

A workstation may comprise the system set forth.

An imaging apparatus may comprise the system set forth.

A method of processing a medical image may comprise receiving the medical image, obtaining an image characteristic of the medical image, categorizing the medical image in dependence on the image characteristic for obtaining a category of the medical image, and configuring a segmentation means by selecting a segmentation algorithm amongst a plurality of segmentation algorithms in dependence on the category, for enabling the segmentation means to segment the medical image with the segmentation algorithm for obtaining a region of interest.

A computer program product may comprise instructions for causing a processor system to perform the method set forth.

It will be appreciated by those skilled in the art that two or more of the above-mentioned embodiments, implementations, and/or aspects of the invention may be combined in any way deemed useful.

Modifications and variations of the imaging apparatus, the workstation, the method, and/or the computer program product, which correspond to the described modifications and variations of the system, can be carried out by a person skilled in the art on the basis of the present description.

A person skilled in the art will appreciate that the method may be applied to multi-dimensional image data, e.g. to two-dimensional (2-D), three-dimensional (3-D) or four-dimensional (4-D) images, acquired by various acquisition modalities such as, but not limited to, standard X-ray Imaging, Computed Tomography (CT), Magnetic Resonance Imaging (MRI), Ultrasound (US), Positron Emission Tomography (PET), Single Photon Emission Computed Tomography (SPECT), and Nuclear Medicine (NM). A dimension of the multi-dimensional image data may relate to time. For example, a three-dimensional image may comprise a time domain series of two-dimensional images.

The invention is defined in the independent claims. Advantageous embodiments are defined in the dependent claims.

### BRIEF DESCRIPTION OF THE DRAWINGS

These and other aspects of the invention are apparent from and will be elucidated with reference to the embodiments described hereinafter. In the drawings,

FIG. 1 shows a system for processing a medical image;

FIG. 2 shows a method of processing a medical image;

FIG. 3 shows a monotonically declining intensity frequency distribution;

FIG. 4 shows an intensity frequency distribution comprising a peak;

FIG. 5 shows an example of a medical image of a first category;

FIG. 6 shows an example of a medical image of a second category.

### DETAILED DESCRIPTION OF EMBODIMENTS

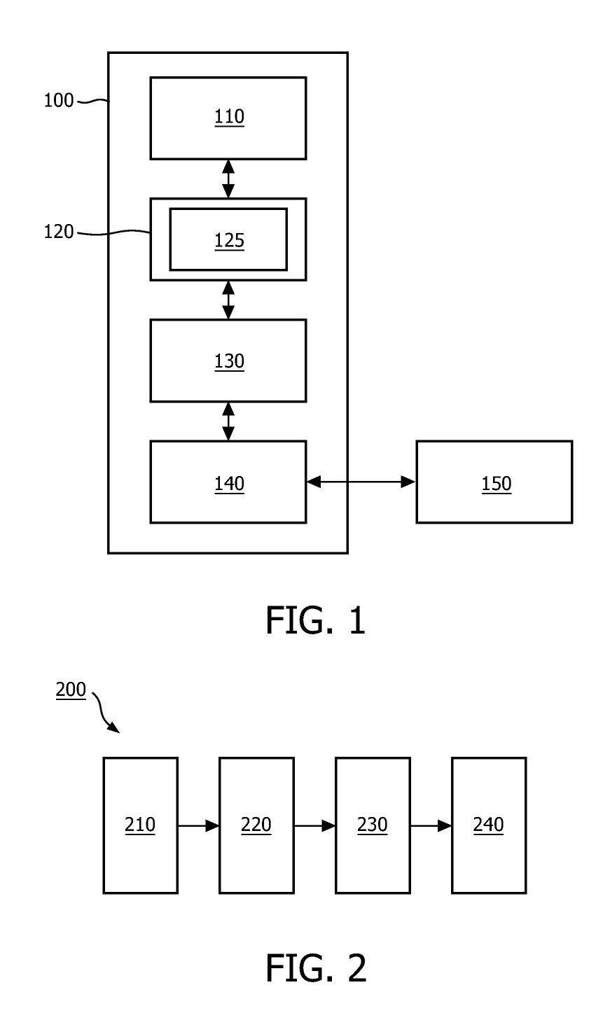

FIG. 1 shows a system 100 for processing a medical image. The input 110 is shown to be connected to the processor 120 for providing a received medical image to the processor 120. The processor 120 is shown to be connected to the categorizer 130 for providing the image characteristic to the categorizer 130. The categorizer 130 is shown to be connected to the algorithm selector 140 for providing the category to the algorithm selector 140. The algorithm selector 140 is shown to be connected to a segmentation means 150 for configuring the segmentation means 150. The segmentation means 150 is shown to be an external segmentation means, i.e., that is not part of the system 100. Alternatively, the segmentation means 150 may be an internal segmentation means.

During operation of the system 100, the input 110 may receive a medical image. The processor 120 then obtains an image characteristic of the medical image. The categorizer 130 categorizes the medical image in dependence on the image characteristic to obtain a category of the medical image. Subsequently, the algorithm selector 140 configures the segmentation means 150 using the category. This is done by selecting a segmentation algorithm from among a plurality of segmentation algorithms within the segmentation means 150. The selection is performed in dependence on the category. As a result, the medical image can be segmented with the particular segmentation algorithm.

The image characteristic that is obtained by the processor 120 may be an image characteristic that is of particular value for categorizing the medical image. Such image characteristics may include an intensity distribution of at least a portion of the medical image. An example of an intensity distribution is an intensity frequency distribution. Similarly, the image characteristic may relate to contrast, noise-level or sharpness of at least a portion of the medical image. Such image characteristics may be obtained from the medical image, using techniques known from the technical field of image analysis. For example, for obtaining the contrast of the medical image, a contrast measurement may be used. Similarly, for obtaining an intensity frequency distribution of the medical image, an intensity histogram may be used. It will be appreciated that many techniques are known, and thus may be used by the processor 120, for obtaining any of the image characteristics mentioned hereinabove and hereinafter.

Alternatively, or in addition to obtaining the image characteristics from the medical image, the image characteristics may also be obtained from metadata that is received by the input 110 and that is associated with the medical image. The metadata may be indicative of, e.g., the acquisition modality or an acquisition parameter. Hence, the processor 120 may use the metadata to obtain image characteristics such as, e.g., type of the organ shown. The metadata may also be indirectly indicative of the image characteristics. For example, the metadata may comprise patient data such as a body mass index of the patient, which may be indicative of a size or contrast of an organ that is shown in the medical image.

The categorizer 130 uses the image characteristic to categorize the medical image by assigning a category to the medical image. Hence, the medical image is assigned one of a number of categories. The category may be represented by a number, a symbol or a text, or any combination of those. The number of categories, and the exact manner of categorization, depends partially on the segmentation algorithms within the segmentation means. Generally, it may be desirable to have a number of categories that matches the number of segmentation algorithms. However, there may also be more categories than segmentation algorithms, for example, if for certain categories it is desirable not to segment the medical image. In a specific example, a category may indicate that there is no region of interest within the medical image, and thus, that segmentation is not needed.

The categorizer 130 may categorize the medical image by comparing the image characteristic of the received medical image with a set of reference image characteristics, with each reference image characteristic having an associated category. Hence, the categorizer 130 may provide the category of the reference image characteristic that matches the image characteristic. In a specific example, the image characteristic may relate to a contrast value of the medical image. The categorizer 130 may compare the contrast value with a set of reference contrast value ranges, e.g., ranging from low contrast to high contrast. Each of the contrast value ranges may have an associated category. Each of the categories may have an associated segmentation algorithm. Thus, there may be a segmentation algorithm that is optimized for low contrast medical images, and one that is optimized for high contrast medical images. The categorizer 130 may therefore provide the category of the reference contrast value range in which the contrast value of the medical image falls.

It will be appreciated that the categorizer 130 may use any other suitable categorization technique. For example, in the technical fields of pattern recognition and statistical classification, many solutions are known for assigning a category to input data. For example, in the case that the image characteristic comprises two values, e.g., a contrast value and a noise value, a quadratic classification technique may be used to differentiate between the many possible combinations of contrast and noise values for assigning an appropriate category to each combination. The image characteristic may therefore be seen as a so-termed vector of features, i.e., an observation vector, and a quadratic classifier may be used to determine what the corresponding category should be. The exact manner of categorization may be manually determined. Alternatively, techniques from the technical field of machine learning may be used to optimally determine the manner of classification. For example, k-nearest neighbor classifiers, maximum entropy classifiers, Naive Bayes classifiers, support vector machines, decision trees, neural networks, etc. may be used.

The algorithm selector 140 selects a segmentation algorithm from among a plurality of segmentation algorithms within the segmentation means 150. The selection is performed in dependence on the category. For that purpose, the algorithm selector 140 may provide a segmentation algorithm identifier to the segmentation means 150 in dependence on the category, with the segmentation algorithm identifier identifying a particular one of the segmentation algorithms. The segmentation means 150 may then use the segmentation algorithm identifier to select the particular segmentation algorithm. The algorithm selector 140 may also directly provide the category to the segmentation means 150. The segmentation means may then use the category directly to select the particular segmentation algorithm. Alternatively, the functionality of the algorithm selector 140 may be integrated into the categorizer 130. Consequently, the categorizer 130 may directly provide a category or segmentation algorithm identifier to the segmentation means 150.

The segmentation means 150 comprises a plurality of segmentation algorithms for segmenting the medical image. As a result of the segmentation, a region of interest is obtained. The region of interest may be, e.g., an organ within the medical image. The region of interest may also relate to a part of the organ, to a human structure, to a medical anomaly, or to a physiological aspect of the medical image. The segmentation algorithms may have in common that they segment a similar type of region of interest, e.g., an organ such as a heart. Alternatively, the segmentation algorithms may each segment a different type of region of interest, with a first algorithm segmenting, e.g., a heart, a second algorithm segmenting, e.g., a lung, etc. Of course, combinations of both are equally possible.

It will be appreciated that each segmentation algorithm may be any known segmentation algorithm from the technical field of image processing, and in particular, from the technical field of medical image processing. For example, the segmentation algorithm may be any known edge detection-based segmentation algorithm. Also, it may be based on known segmentation techniques such as region growing, clustering, watershed transformation, model-based segmentation, etc. The plurality of segmentation algorithms may be formed by segmentation algorithms that are each based on a different segmentation technique. The plurality of segmentation algorithms may also be formed by segmentation algorithms based on the same segmentation technique, but having differing parameter values or optimizations.

The image characteristic may relate to the entire medical image or to a portion of the medical image. The portion may be a fixed portion of the medical image. For example, an intensity distribution in the lower left quadrant of the medical image may be used to categorize the medical image. The lower left quadrant may be used as it may be known that a particular organ is located in this quadrant. Thus, the image characteristic of the particular organ located in the lower left quadrant may be used to categorize the medical image.

The image characteristic may also relate to a particular object within the medical image, such as an organ, human structure, medical anomaly, or physiological aspect, without prior knowledge of the exact location of the particular object within the medical image. In particular, the image characteristic may relate to, or comprise, one or more intensity values of an organ. For obtaining the image characteristic of the particular object, the processor 120 may further comprise a pre-segmentation means 125. Similar to the aforementioned segmentation algorithms, the pre-segmentation means 125 may be based on any known segmentation technique. Therefore, the pre-segmentation algorithm may be similar to a segmentation algorithm from the segmentation means 150. Typically, however, the pre-segmentation algorithm differs from the segmentation algorithms from the segmentation means 150. For example, the pre-segmentation algorithm may provide a relatively coarse segmentation to reduce the complexity of the pre-segmentation algorithm. The pre-segmentation algorithm may also be optimized for over-segmentation for ensuring that the segmented region at least comprises the object. After a segmented object has been obtained, the processor 120 may provide the image characteristic by determining, e.g., a location, size, shape, average intensity or intensity distribution, of the segmented object.

The medical image may be acquired by any known imaging modality. In particular, the medical image may be a functional medical image, i.e., representing a physiological activity within a human or animal body. The categorization according to the present invention may be of particular relevance for functional medical images, as anatomical information is minimal and therefore different segmentation algorithms may need to be used to localize an organ or region of interest within the different categories of functional images. Such a functional medical image may be obtained by, for example, Positron Emission Tomography (PET), SPECT, Scintigraphy, Optical, functional Magnetic Resonance Imaging (fMRI), functional Ultrasound, etc. Alternatively, the medical image may be a structural medical image, i.e., representing a structure of the human or animal body.

In a specific embodiment of the system 100, the medical image may be a medical image of a heart obtained by SPECT. The medical image may also comprise other organs such as the liver or abdominal structures. For obtaining the image characteristic, the processor 120 is arranged for generating a normalized intensity histogram. This may be done by first normalizing the medical image before generating the intensity histogram, e.g., by adjusting the intensity values such that the lowest occurring intensity value is mapped to zero, and the highest occurring intensity value is mapped to the highest possible intensity value. Alternatively, the histogram itself may be normalized after being generated.

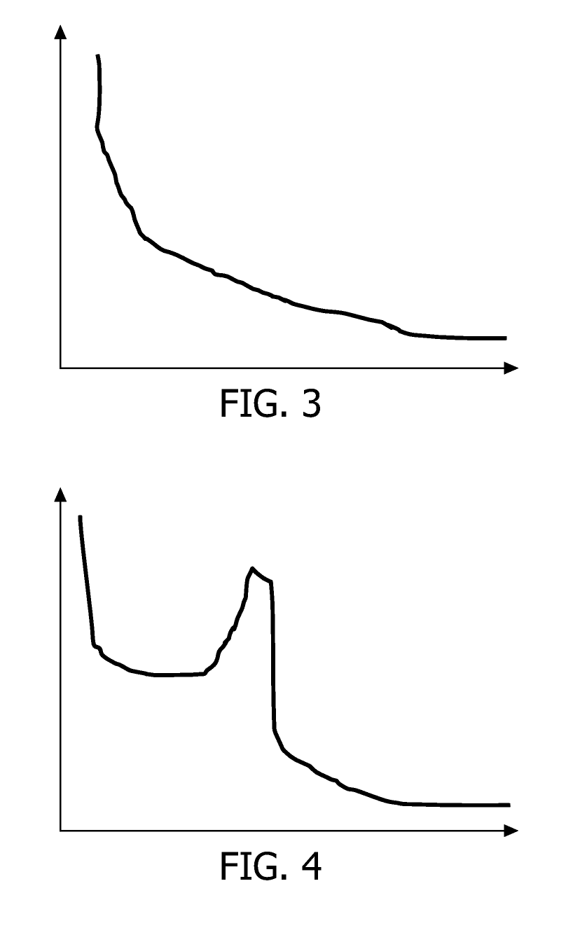

The categorizer 130 then classifies the received medical image into either of two broad categories of normalized histogram profiles. The first category has a continuous falling profile, as shown in FIG. 3, and the other category has a profile with significant local maxima and minima, as shown in FIG. 4. Here, the horizontal axis represents the intensity value or frequency index, and the vertical axis represents its occurrence or frequency within the medical image. The first category is associated with images with clear heart intensities. The second category may have heart intensities dominating, but there may be other structures dominating as well along with the heart, e.g., a lung or an abdominal structure.

For differentiating between the two categories, the categorizer 130 may determine whether a peak exists within the normalized intensity histogram. The corresponding frequency index of the peak may be used for categorization. For example, if a peak is detected that has a frequency index higher than “10”, the medical image may be considered as belonging to the second category. Otherwise, the medical image may be considered as belonging to the first category. “10” may be an experimentally derived value. The categories may also be sub-divided into sub-categories. This may be considered equivalent to having a number of categories that corresponds to the number of sub-categories, with the difference that all sub-categories belonging to a category share a common property.

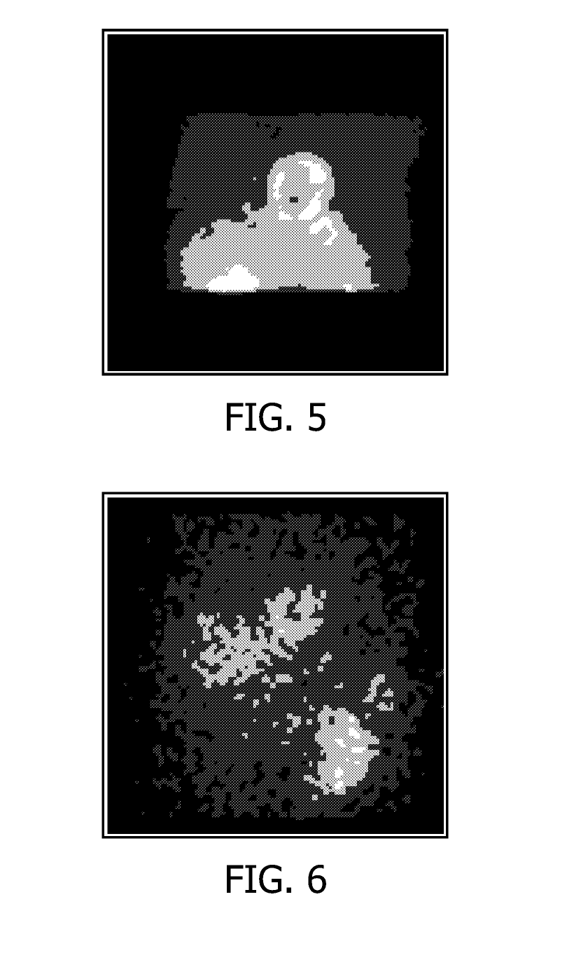

The first category may relate to medical images that predominantly show heart intensities that do not overlap with other organs. An example of a medical image belonging to the first category is shown in FIG. 5. The second category may relate to medical images that do not predominantly show heart intensities. A first sub-category of the second category may relate to medical images showing overlapping liver and abdominal intensities along with the heart, with all the intensities dominating. A second sub-category may relate to medical images showing suppressed heart intensities, whereas liver and abdominal intensities are dominating. A third sub-category may relate to medical images in which noise is dominating. An example of a medical image belonging to the third sub-category is shown in FIG. 6. Lastly, a fourth sub-category may relate to medical images in which heart intensities are heavily suppressed, with noise and liver intensities dominating the medical image.

The reason for the differing medical images may be differences in the acquisition of the medical image and/or differences in a medical condition of the patient. For example, noise may be dominating within the medical image if the patient suffers from a heart condition that results in the heart having low intensity values within the medical image. Thus, noise may be relatively dominant compared to the intensity values of the heart.

For each of the categories and sub-categories, a different segmentation algorithm is selected. For example, for the first category, a relatively standard segmentation algorithm may be selected, in which a threshold is first determined from a histogram of the medical image, the threshold is applied to the medical image to obtain a first segmentation of the heart, a circle detection and verification is used, and then the heart is localized. For the first sub-category of the second category, the liver may additionally be detected and removed. Also, for the third and fourth sub-categories, noise reduction or noise smoothing may additionally be applied after applying the threshold to the medical image.

In another specific embodiment of the system 100, the medical image may be a so-termed non-gated cardiac Magnetic Resonance (MR) image, in which liver, lung and heart may be overlapping. Such overlap may vary greatly between patients, and may be highly dependent upon how the medical image was acquired. To adapt the segmentation to the overlap, the processor 120 is configured for determining an overlap between the lung and non-lung portions, the categorizer 130 is configured for classifying the medical image in dependence on the determined overlap, and the algorithm selector 140 is configured for selecting from among differently seeded region growing segmentation algorithms, i.e., region growing segmentation algorithms each having a different initial seed location.

The processor 120 is configured for performing a pre-segmentation of the lung and non-lung portions of the medical image, such as those containing the heart. From this, an overlap can be determined. The categorizer 130 then classifies the received medical image into three categories of overlap. The first category relates to medical images showing a heart and liver having an overlap of less than 5%. The second category relates to medical images showing a heart and liver having an overlap between 5% and 20%. The third category relates to medical images showing a heart and liver having an overlap of more than 20%. The third category may be indicative of a relatively obese patient. The overlap percentages of 5% and 20% may be experimentally derived percentages.

For each of the categories, a different segmentation algorithm is selected. All segmentation algorithms may have in common that they comprise a lung segmentation based on region growing using a so-termed seed location. Here, the region of interest initially comprises the seed location, and neighboring regions are iteratively analyzed to determine whether said regions should be added to the region of interest. Consequently, the region of interest ‘grows’ during a number of iterations. All segmentation algorithms may differ in how the seed location is calculated. For example, for the first category, a relatively standard base model may be used for calculating the seed location. For the second category, the base model may be adjusted for a small overlap between heart and liver. For the third category, the base model may be adjusted for a relatively large overlap between heart and liver. Thus, the lung may be segmented, and a lung location may be obtained. From this, all segmentation algorithms may derive a seed location of the left ventricle of the heart for performing a region growing segmentation algorithm, for obtaining a segmented left ventricle of the heart.

The system 100 shown is built up of a number of blocks: an input 110, a processor 120, a categorizer 130 and an algorithm selector 140. The processor 120 is shown to comprise a pre-segmentation means 125. Each of these blocks may be partially or completely implemented in software. The input 110 may be implemented as a computer file reader, memory reader, internet packet receiver, or any other suitable means for receiving the medical image. The system 100 further may comprise (not shown): a general purpose processor, a storage means, and a communications port. The general purpose processor may be arranged for executing instructions that are part of a medical image processing program. The storage means may comprise RAM, ROM, hard disk, removable media such as CD and DVD. The storage means can be used for storing the computer instructions and/or for storing the medical image. The communications port can be used for communications with another computer system, for example a server. The communications port can be arranged for being connected to a network such as a local area network, wide area network, and/or the Internet. The other computer system may be reached via the network for retrieving, e.g., the medical image and/or associated metadata.

FIG. 2 shows a method 200 of processing a medical image. The method comprises receiving 210 the medical image, obtaining 220 an image characteristic of the medical image, categorizing 230 the medical image in dependence on the image characteristic for obtaining a category of the medical image, and configuring 240 a segmentation means by selecting a segmentation algorithm from among a plurality of segmentation algorithms in dependence on the category, for enabling the segmentation means to segment the medical image with the segmentation algorithm for obtaining a region of interest.

It will be appreciated that the invention also applies to computer programs, particularly computer programs on or in a carrier, adapted to put the invention into practice. The program may be in the form of a source code, an object code, a code intermediate source and object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or be used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for processing a medical image, the system comprising:
an input for receiving the medical image;
a processor for obtaining an image characteristic of the medical image by determining an intensity frequency distribution of at least a first portion of the medical image;
a categorizer for obtaining a category of the medical image by i) determining a slope or a peak of the intensity frequency distribution; and ii) categorizing the medical image in dependence on the slope or the peak; and
an algorithm selector for configuring a segmentation means by selecting a segmentation algorithm from among a plurality of segmentation algorithms in dependence on the category, for enabling the segmentation means to segment the medical image with the segmentation algorithm for obtaining a region of interest.

2. (canceled)

3. (canceled)

4. (canceled)

5. The system according to claim 1, wherein the processor comprises a pre-segmentation means for pre-segmenting the medical image for obtaining the first portion of the medical image, and the processor is configured for obtaining the image characteristic from the first portion.

6. The system according to claim 5, wherein the pre-segmentation means is configured for pre-segmenting the medical image with a pre-segmentation algorithm associated with an organ, for obtaining as the first portion a portion of the medical image comprising the organ.

7. The system according to claim 5, wherein the processor is configured for obtaining the image characteristic by determining at least one of the group of: location, size, shape, average intensity or intensity distribution, of the first portion.

8. The system according to claim 5, wherein the pre-segmentation means is further configured for pre-segmenting the medical image for obtaining a second portion of the medical image, the processor is configured for obtaining a further image characteristic from the second portion, and the categorizer is configured for categorizing the medical image by:
comparing the image characteristic with the further image characteristic; and
categorizing the medical image in dependence on the result of the comparing action.

9. The system according to claim 8, wherein the result of the comparing action is indicative of an overlap between the first portion and the second portion within the medical image.

10. The system according to claim 1, wherein the processor is configured for obtaining the image characteristic by determining at least one of the group of: contrast, noise-level or sharpness, of at least a first portion of the medical image.

11. The system according to claim 1, wherein the input is further configured for receiving metadata associated with the medical image, and the processor is configured for obtaining the image characteristic of the medical image from the metadata.

12. A workstation comprising the system according to claim 1.

13. An imaging apparatus comprising the system according to claim 1.

14. A method of processing a medical image, the method comprising:
receiving the medical image;
obtaining an image characteristic of the medical image by determining an intensity frequency distribution of at least a first portion of the medical image;
categorizing the medical image by i) determining a slope or a peak of the intensity frequency distribution; and ii) categorizing the medical image in dependence on for obtaining a category of the medical image; and
configuring a segmentation means by selecting a segmentation algorithm from among a plurality of segmentation algorithms in dependence on the category, for enabling the segmentation means to segment the medical image with the segmentation algorithm for obtaining a region of interest.

15. A computer program product comprising instructions for causing a processor system to perform the method according to claim 14.
